(19) United States
(12) Patent Application Publication
(10) Pub. No.: US 2015/0264439 A1
(43) Pub. Date: Sep. 17, 2015

(54) CONTEXT AWARENESS FOR SMART TELEVISIONS

(71) Applicant: HILLCREST LABORATORIES, INC., Rockville, MD (US)

(72) Inventors: Dave Karlin, Rockville, MD (US); Chuck Gritton, Rockville, MD (US); Steve Francz, Rockville, MD (US); Fred Geck, Rockville, MD (US); Roy Illingworth, Rockville, MD (US); Mark Turner, Rockville, MD (US); Bill Rouady, Rockville, MD (US); Kit Wood, Rockville, MD (US); Seth Sternberg, Rockville, MD (US); Dave Coleman, Rockville, MD (US)

(21) Appl. No.: 14/438,704

(22) PCT Filed: Oct. 28, 2013
(86) PCT No.: PCT/US2013/067024

§ 371 Date: Apr. 27, 2015

Related U.S. Application Data
(60) Provisional application No. 61/719,442, filed on Oct. 28, 2012.

(51) Int. Cl. H04N 21/466; H04N 21/442; H04N 21/475; H04N 21/443; H04N 21/422; H04N 21/4223

(52) U.S. Cl. CPC H04N 21/4667; H04N 21/42202; H04N 21/42203; H04N 21/42222; H04N 21/4223; H04N 21/4751; H04N 21/443; H04N 21/44218; H04N 21/44222

(57) ABSTRACT

Context awareness enables devices, e.g., smart televisions, to perform context-based actions without requiring user interaction. This enables users to more rapidly access desired content or applications via these devices without needing to navigate complicated user interfaces.

### BACKGROUND

The present invention describes context awareness techniques, as well as devices, systems and software which can implement actions which are responsive to context awareness, including (but not limited to) smart televisions.

Technologies associated with the communication of information have evolved rapidly over the last several decades. Television, cellular telephony, the Internet and optical communication techniques (to name just a few modes of communications) combine to inundate consumers with available information and entertainment options. Taking television as an example, the last three decades have seen the introduction of cable television service, satellite television service, pay-per-view movies and video-on-demand, both of the latter being made available by cable, fiber-optic, and satellite service providers, as well as over the internet (e.g., Netflix®). Whereas television viewers of the 1960s could typically receive perhaps four or five over-the-air TV channels on their television sets, today's TV watchers have the opportunity to select from hundreds, thousands, and potentially millions of channels of shows and information. Video-on-demand technology, currently used primarily in hotels and the like, provides the potential for in-home entertainment selection from among thousands of movie titles.

The technological ability to provide so much information and content to end users provides both opportunities and challenges to system designers and service providers. One challenge is that while end users typically prefer having more choices rather than fewer, this preference is counterweighted by their desire that the selection process be both fast and simple. Unfortunately, the development of the systems and interfaces by which end users access media items has resulted in selection processes which are neither fast nor simple. Consider again the example of television programs. When television was in its infancy, determining which program to watch was a relatively simple process primarily due to the small number of choices. One would consult a printed guide that was formatted, for example, as series of columns and rows which showed the correspondence between (1) nearby television channels, (2) programs being transmitted on those channels and (3) date and time. The television was tuned to the desired channel by adjusting a tuner knob and the viewer watched the selected program. Later, remote control devices were introduced that permitted viewers to tune the television from a distance. This addition to the user-television interface created the phenomenon known as “channel surfing” whereby a viewer could rapidly view short segments being broadcast on a number of channels to quickly learn what programs were available at any given time.

Despite the fact that the number of channels and amount of viewable content has dramatically increased, the generally available user interface, control device options and frameworks for televisions has not changed much over the last 30 years. Printed guides, and their displayed counterparts on a guide channel, are still the most prevalent mechanism for conveying programming information. The multiple button remote control 100, an example of which is illustrated in FIG. 1 with up 102, down 104, left 106 and right 108 arrows, is still the most prevalent channel/content selection mechanism. The reaction of those who design and implement the TV user interface to the increase in available media content has been a straightforward extension of the existing selection procedures and interface objects. Thus, the number of rows in the printed guides has been increased to accommodate more channels. The number of buttons on the remote control devices has been increased to support additional functionality and content handling. However, this approach has significantly increased both the time required for a viewer to review the available information and the complexity of actions required to implement a selection. For example, in a large grid guide supporting hundreds of channels, a user may have to perform 50 or a 100 up-down-left-right button presses to navigate the grid guide and make a content selection. Arguably, the cumbersome nature of the existing interface has hampered commercial implementation of some services, e.g., video-on-demand, since consumers are resistant to new services that will add complexity to an interface that they view as already too slow and complex.

Some attempts have also been made to modernize the screen interface between end users and media systems. However, these attempts typically suffer from, among other drawbacks, an inability to easily scale between large collections of media items and small collections of media items. For example, interfaces which rely on lists of items may work well for small collections of media items, but are tedious to browse for large collections of media items. Interfaces which rely on hierarchical navigation (e.g., tree structures) may be speedier to traverse than list interfaces for large collections of media items, but are not readily adaptable to small collections of media items. Additionally, users tend to lose interest in selection processes wherein the user has to move through three or more layers in a tree structure. For all of these cases, current remote units make this selection process even more tedious by forcing the user to repeatedly depress the up and down buttons to navigate the list or hierarchies. When selection skipping controls are available such as page-up and page-down, the user usually has to look at the remote to find these special buttons or be trained to know that they even exist. Accordingly, organizing frameworks, techniques and systems that simplify the control and screen interface between users and media systems as well as accelerate the selection process, while at the same time permitting service providers to take advantage of the increases in available bandwidth to end user equipment by facilitating the supply of a large number of media items and new services to the user have been proposed in the Assignee's earlier U.S. patent application Ser. No. 10/768,432, filed on Jan. 30, 2004, entitled “A Control Framework with a Zoomable Graphical User Interface for Organizing, Selecting and Launching Media Items”, the disclosure of which is incorporated here by reference.

In addition to improving the screen interface by which the user interacts with a television, other updates are being made to the television. For example, so-called “smart TVs” now include a number of new features and capabilities which enable them to more easily adapt to the move away from traditional broadcast media, and toward, e.g., online interactive media and on-demand streaming media. The next generation of smart TV's will thus have a number of new data processing and acquisition capabilities, as well as incorporating various sensors and communication technologies which traditional TV's did not possess.

Accordingly, it would be desirable to take advantage of the new capabilities of smart televisions (or other devices) to introduce context awareness and context aware functionality.

### SUMMARY

Context awareness enables devices, e.g., smart televisions, to perform context-based actions without requiring user interaction. This enables users to more rapidly access desired content or applications via these devices without needing to navigate complicated user interfaces.

According to an embodiment, a method for performing a context-based action in a television includes the steps of determining, by the television, at least one piece of context information associated with a current usage of the television; and performing, by the television, the context-based action based on the at least one piece of context information.

According to another embodiment, a smart television system includes a television display; at least one television media input configured to receive television programming signals from at least one of a cable TV network and a satellite TV network; at least one Internet media input configured to receive Internet content; a plurality of sensors including at least two of: a camera, a microphone, an infrared device, and a motion sensor; a processor configured to output television programming or Internet content to the display and further configured to receive inputs from the plurality of sensors, and to determine a context associated with a current usage of the smart television system based, at least in part, on the received inputs, wherein the processor is further configured to use the determined context to perform a context-based action.

According to still another embodiment, a method for performing context based actions by a smart television includes the steps of determining an identity of a user of the smart television; evaluating one or more subcontexts associated with the identified user; and performing the context-based action based on the evaluating.

According to yet another embodiment, a context repository system associated with household devices includes a memory device configured to store a database of context information associated with the household devices, their environment and their users; a plurality of interfaces, each associated with one of the household devices, for receiving context information from the household devices and for transmitting context information to the household devices; a processor configured to receive the context information from the household devices, to store the received context information in the database, and further configured to receive requests for context information from the household devices, to retrieve the requested context information from the database and to transmit the requested context information back to the requesting household devices.

### BRIEF DESCRIPTION OF THE DRAWINGS

The accompanying drawings illustrate exemplary embodiments, wherein:

FIG. 1 depicts a conventional remote control unit for an entertainment system;

FIG. 2 depicts an exemplary media system in which exemplary embodiments can be implemented:

FIG. 3 shows a 3D pointing device;

FIG. 4 illustrates a cutaway view of the 3D pointing device in FIG. 4 including two rotational sensors and one accelerometer;

FIG. 5 shows another 3D pointing device;

FIG. 6 depicts the 3D pointing device of FIG. 5 being used as part of a “10 foot” interface;

FIGS. 7(a)-7(c) depict various aspects of smart TVs according to exemplary embodiments;

FIG. 8 show various exemplary contexts of interest according to embodiments;

FIGS. 9(a)-9(b) depict exemplary context/action pairings according to embodiments;

FIG. 10 shows contexts and applications according to embodiments; and 6

FIGS. 11(a)-11(b) show various aspects of context repositories according to embodiments.

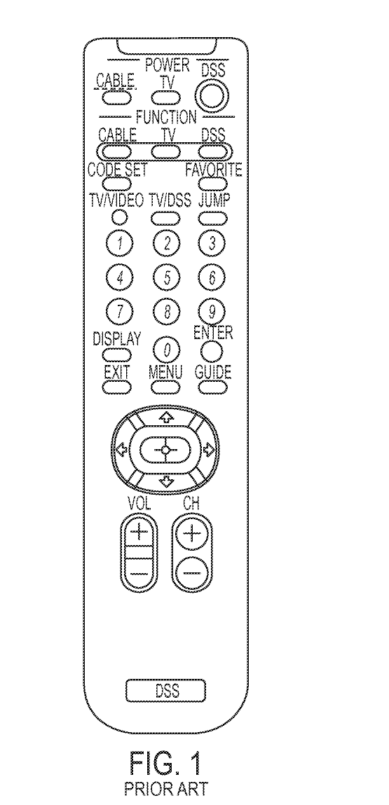

### DETAILED DESCRIPTION

The following detailed description of the invention refers to the accompanying drawings. The same reference numbers in different drawings identify the same or similar elements. Also, the following detailed description does not limit the invention. Instead, the scope of the invention is defined by the appended claims.

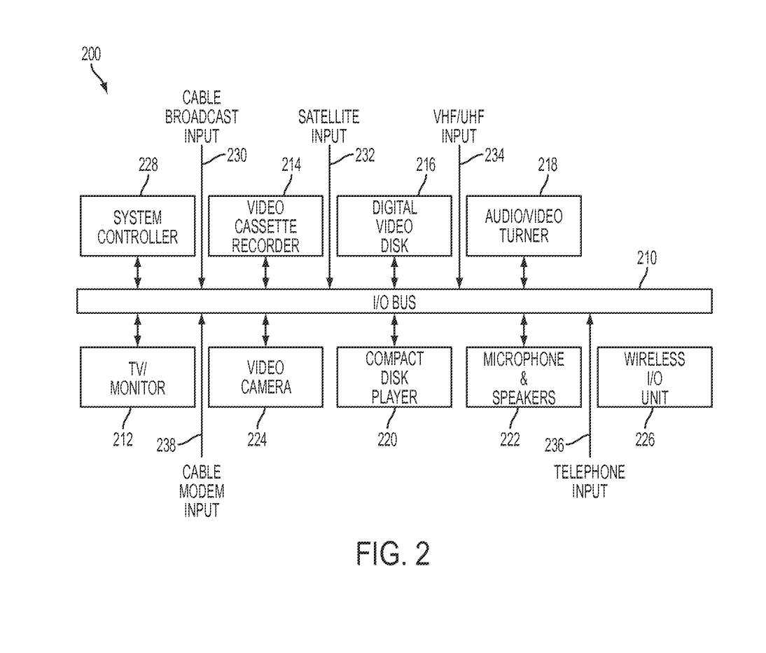

In order to provide some context for this discussion, an exemplary aggregated media system 200 in which the present invention can be implemented will first be described with respect to FIG. 2. Those skilled in the art will appreciate, however, that the present invention is not restricted to implementation in this type of media system and that more or fewer components can be included therein. Therein, an input/output (I/O) bus 210 connects the system components in the media system 200 together. The I/O bus 210 represents any of a number of different of mechanisms and techniques for routing signals between the media system components. For example, the I/O bus 210 may include an appropriate number of independent audio “patch” cables that route audio signals, coaxial cables that route video signals, two-wire serial lines or infrared or radio frequency transceivers that route control signals, optical fiber or any other routing mechanisms that route other types of signals.

In this exemplary embodiment, the media system 200 includes a television (TV)/monitor 212, a video cassette recorder (VCR) 214, digital video disk (DVD) recorder/playback device 216, audio/video tuner 218 and compact disk player 220 coupled to the I/O bus 210. The VCR 214, DVD 216 and compact disk player 220 may be single disk or single cassette devices, or alternatively may be multiple disk or multiple cassette devices. They may be independent units or integrated together. In addition, the media system 200 includes a microphone/speaker system 222, video camera 224 and a wireless I/O control device 226. According to exemplary embodiments of the present invention, the wireless I/O control device 226 is a 3D pointing device according to one of the exemplary embodiments described below. The wireless I/O control device 226 can communicate with the entertainment system 200 using, e.g., an IR or RF transmitter or transceiver. Alternatively, the I/O control device can be connected to the entertainment system 200 via a wire.

The entertainment system 200 also includes a system controller 228. According to one exemplary embodiment of the present invention, the system controller 228 operates to store and display entertainment system data available from a plurality of entertainment system data sources and to control a wide variety of features associated with each of the system components. As shown in FIG. 2, system controller 228 is coupled, either directly or indirectly, to each of the system components, as necessary, through I/O bus 210. In one exemplary embodiment, in addition to or in place of I/O bus 210, system controller 228 is configured with a wireless communication transmitter (or transceiver), which is capable of communicating with the system components via IR signals or RF signals. Regardless of the control medium, the system controller 228 is configured to control the media components of the media system 200 via a graphical user interface described below.

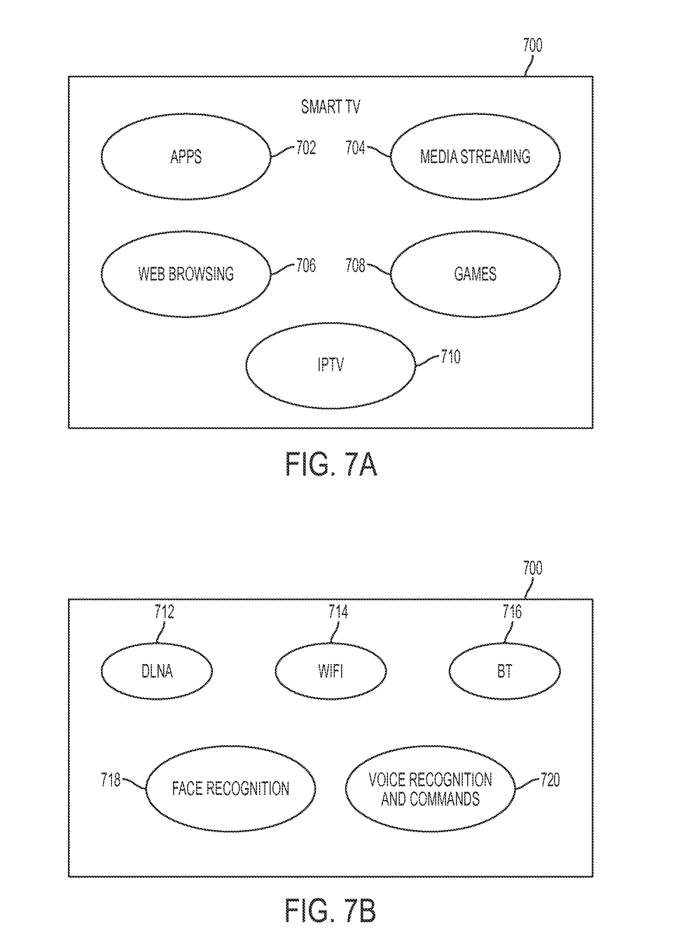

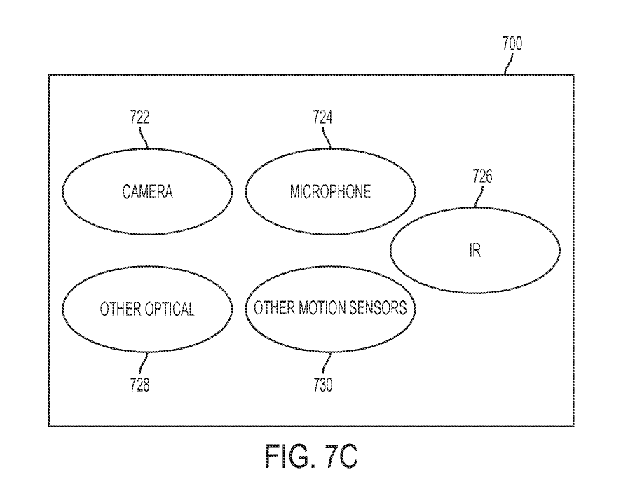

As further illustrated in FIG. 2, media system 200 may be configured to receive media items from various media sources and service providers. In this exemplary embodiment, media system 200 receives media input from and, optionally, sends information to, any or all of the following sources: cable broadcast 230 (e.g., via coaxial cable, or optionally a fiber optic cable), satellite broadcast 232 (e.g., via a satellite dish), very high frequency (VHF) or ultra-high frequency (UHF) radio frequency communication of the broadcast television networks 234 (e.g., via an aerial antenna), telephone network 236 and cable modem 238 (or another source of Internet content). Those skilled in the art will appreciate that the media components and media sources illustrated and described with respect to FIG. 2 are purely exemplary and that media system 200 may include more or fewer of both. For example, other types of inputs to the system include AM/FM radio and satellite radio. Moreover, as will be described below with respect to FIGS. 7(a) and 7(b), TV/monitor 212 can be implemented as a smart TV having additional features and components.

More details regarding this exemplary entertainment system and frameworks associated therewith can be found in the above-incorporated by reference U.S. patent application “A Control Framework with a Zoomable Graphical User Interface for Organizing, Selecting and Launching Media Items”. Alternatively, remote devices in accordance with the present invention can be used in conjunction with other systems, for example computer systems including, e.g., a display, a processor and a memory system or with various other systems and applications.

A remote control device can also be provided to assist the user in controlling the system 200 or components thereof, e.g., a smart TV. According to one embodiment, remote devices which operate as 3D pointers can be used as such remote control devices, although this is not a requirement of the invention. Such devices enable the translation of movement, e.g., gestures, into commands to a user interface. An exemplary 3D pointing device 400 is depicted in FIG. 3. Therein, user movement of the 3D pointing can be defined, for example, in terms of a combination of x-axis attitude (roll), y-axis elevation (pitch) and/or z-axis heading (yaw) motion of the 3D pointing device 400. In addition, some exemplary embodiments of the present invention can also measure linear movement of the 3D pointing device 400 along the x, y, and z axes to generate cursor movement or other user interface commands. In the exemplary embodiment of FIG. 3, the 3D pointing device 400 includes two buttons 402 and 404 as well as a scroll wheel 406, although other exemplary embodiments can include other physical configurations.

According to exemplary embodiments, it is anticipated that 3D pointing devices 400 will be held by a user in front of a display or smart TV 408 and that motion of the 3D pointing device 400 will be translated by the 3D pointing device into output which is usable to interact with the information displayed on display 408, e.g., to move the cursor 410 on the display 408. For example, rotation of the 3D pointing device 400 about the y-axis can be sensed by the 3D pointing device 400 and translated into an output usable by the system to move cursor 410 along the y₂ axis of the display 408. Likewise, rotation of the 3D pointing device 408 about the z-axis can be sensed by the 3D pointing device 400 and translated into an output usable by the system to move cursor 410 along the x₂ axis of the display 408. It will be appreciated that the output of 3D pointing device 400 can be used to interact with the display 408 in a number of ways other than (or in addition to) cursor movement, for example it can control cursor fading, volume or media transport (play, pause, fast-forward and rewind). Input commands may include operations in addition to cursor movement, for example, a zoom in or zoom out on a particular region of a display. A cursor may or may not be visible. Similarly, rotation of the 3D pointing device 400 sensed about the x-axis of 3D pointing device 400 can be used in addition to, or as an alternative to, y-axis and/or z-axis rotation to provide input to a user interface.

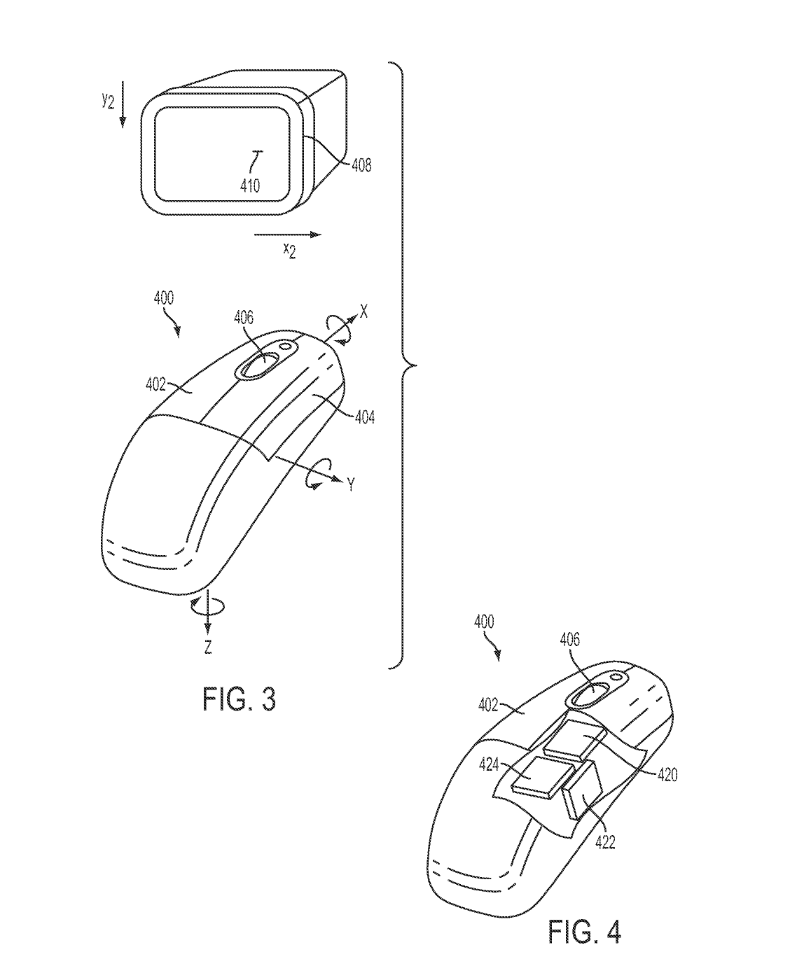

According to one purely illustrative exemplary embodiment, two rotational sensors 420 and 422 and one accelerometer 424 can be employed as sensors in 3D pointing device 400 as shown in FIG. 4. Although this exemplary embodiment employs inertial sensors to sense motion it will be appreciated that the present invention is not so limited and examples of other types of sensors which can be used in conjunction with other exemplary embodiments include, for example, magnetometers and optical devices. The rotational sensors 420 and 422 can, for example, be implemented using ADXRS150 or ADXRS401 sensors made by Analog Devices. It will be appreciated by those skilled in the art that other types of rotational sensors can be employed as rotational sensors 420 and 422 and that the ADXRS150 and ADXRS401 are purely used as an illustrative example.

Unlike traditional gyroscopes, these exemplary rotational sensors use micro electromechanical systems (MEMS) technology to provide a resonating mass which is attached to a frame so that it can resonate only along one direction. The resonating mass is displaced when the body to which the sensor is affixed is rotated around the sensor's sensing axis. This displacement can be measured using the Coriolis acceleration effect to determine an angular velocity associated with rotation along the sensing axis. If the rotational sensors 420 and 422 have a single sensing axis (as for example the ADXRS150s), then they can be mounted in the 3D pointing device 400 such that their sensing axes are aligned with the rotations to be measured. For this exemplary embodiment of the present invention, this means that rotational sensor 422 is mounted such that its sensing axis is parallel to the y-axis and that rotational sensor 420 is mounted such that its sensing axis is parallel to the z-axis as shown in FIG. 4.

It will be appreciated that different sensor packages may be available which could lead to other exemplary implementations. For example, the two 1-D rotational sensors 420 and 422 could be replaced by a single, 2D rotational sensor package which provides outputs of rotational motion along, e.g., the y and z axes. One exemplary 2-D rotational sensor is the InvenSense IDG-300, although it will be appreciated that other sensors/sensor packages may also be used. The rotational sensors 420, 422 can be 1-D, 2-D or 3-D sensors. The accelerometer 424 can, for example, be a 3-axis linear accelerometer, although a 2-axis linear accelerometer could be used by assuming that the device is measuring gravity and mathematically computing the remaining 3^{rd} value. Additionally, the accelerometer(s) and rotational sensor(s) could be packaged together into a single sensor package. Other variations of sensors and sensor packages may also be used in conjunction with these exemplary embodiments.

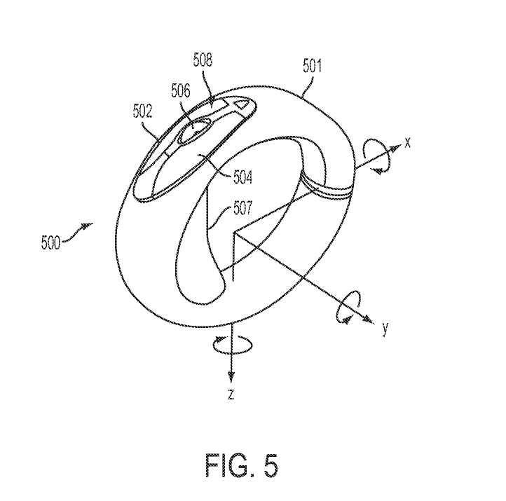

The exemplary embodiments are not limited to the industrial design illustrated in FIGS. 3 and 4, but can instead be deployed in any industrial form factor, another example of which is illustrated as FIG. 5. In the exemplary embodiment of FIG. 5, the 3D pointing device 500 includes a ring-shaped housing 501, two buttons 502 and 504 as well as a scroll wheel 506 and grip 507, although other exemplary embodiments may include other physical configurations. The region 508 which includes the two buttons 502 and 504 and scroll wheel 506 is referred to herein as the “control area” 508, which is disposed on an outer portion of the ring-shaped housing 501. More details regarding this exemplary embodiment can be found in U.S. patent application Ser. No. 11/480,662, entitled “3D Pointing Devices”, filed on Jul. 3, 2006, the disclosure of which is incorporated here by reference. [

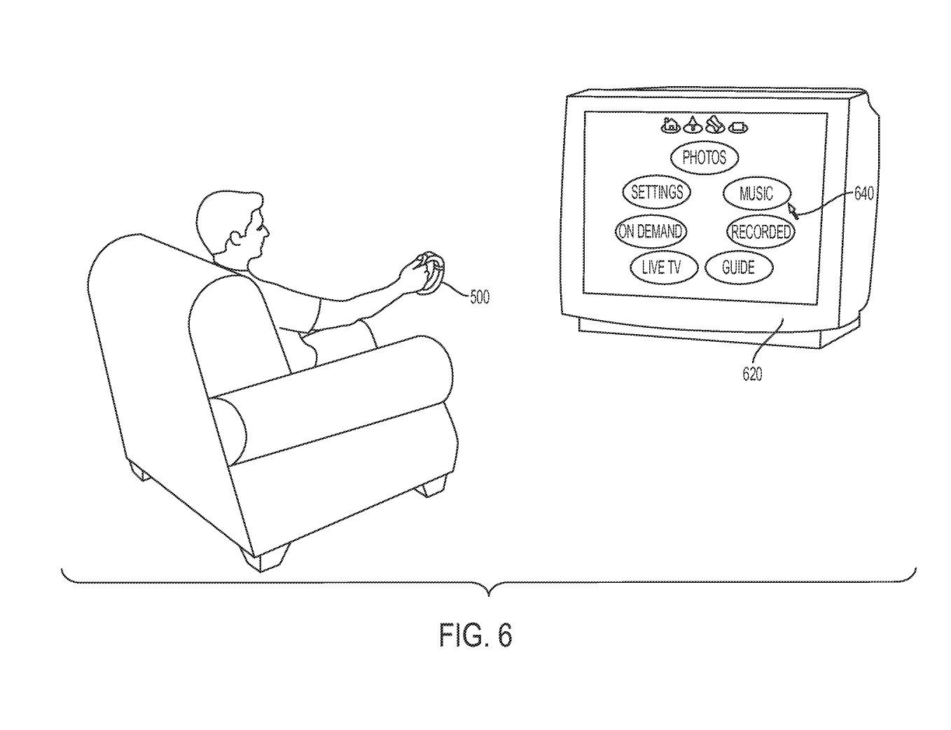

Such 3D pointing devices have numerous applications including, for example, usage in the so-called “10 foot” interface between a sofa and a television in the typical living room as shown in FIG. 6. Therein, as the 3D pointing device 500 moves between different positions, that movement is detected by one or more sensors within 3D pointing device 500 and transmitted to the smart television 620 (or associated system component, e.g., a set-top box (not shown)). Alternatively, or in combination with internal detection of motion, movement of the remote control device can be detected by the smart television 620. Movement of the 3D pointing device 500 can, for example, be translated into movement of a cursor 640 displayed on the smart television 620 and which is used to interact with a user interface. Details of an exemplary user interface with which the user can interact via 3D pointing device 500 can be found, for example, in the above-incorporated U.S. patent application Ser. No. 10/768,432 as well as U.S. patent application Ser. No. 11/437,215, entitled “Global Navigation Objects in User Interfaces”, filed on May 19, 2006, the disclosure of which is incorporated here by reference.

Smart television 620 can include various processing elements, sensors and transmitters which are not normally found in “regular” TVs. Like a smartphone, a smart TV offers a number of “Internet-connected services” that normal televisions can't offer. Smart TVs have processing power which can be substantially similar to that of a computer built into them, giving users a greater number of services. As shown in FIG. 7(a), and considering a smart TV from a service level, smart TVs 700 typically offer apps 702, e.g., Skype, media streaming 704, Web browsing 706, games 708 and/or Internet Protocol Television (IPTV) 710. IPTV is a specific Internet video standard, but this terminology is also used today as shorthand for any video streamed via the Internet to a user's TV, which can take the form of short clips or continuous “live” channels. Considering smart TV's from a technology level, such smart TV's 700 can also include Digital Living Network Alliance (DLNA) streaming technology 712, WiFi (and/or Ethernet) 714 for Internet connectivity, Bluetooth 716 for short range wireless connectivity with, e.g., the remote control device, smartphones, tablets, etc., face recognition technology 718 and/or voice recognition and command technology 720.

As shown in FIG. 7(c), one can also consider smart TVs 700 from a sensor perspective, as it is anticipated that smart TVs will have a growing number of sensors to enable them to receive information about the users and their environment. For example, a smart TV 700 can include a camera 722, a microphone, one or more infrared detectors 726, other optical sensor(s) 728 and/or other (i.e., relative to a motion sensing remote device) motion sensors 730. Those skilled in the art will appreciate that the examples provided in FIGS. 7(a)-7(c) are purely illustrative and that additional or fewer services, technologies and/or sensors may be included in any given smart TV 700. To be specific, any subset of the services, technologies and/or sensors 702-730 are contemplated for inclusion in smart TV's according to these embodiments, however the present invention is not limited to usage with such smart TVs. Also, although not shown in FIGS. 7(a)-7(c), it will be appreciated that smart TV 700 can also include some or all of the components typically found in a computer, e.g., one or more processors, one or more memory devices, etc.

### Context Awareness

With the advent of smart TVs (and more generally, other smart devices) and their enhanced capabilities, comes the possibility for the smart TV to determine a context in which it is being used and then to use the determined context to adjust the manner in which the smart TV is operating and/or outputting content to the user. Embodiments described herein explore the potential types of interesting, new user experiences which can be provided by the system if the smart TV knows the context of the user(s) which are interacting with the smart TV. Thus, in terms of these embodiments, the concept of context awareness describes the capability of a device, e.g., a smart TV, to determine a context associated with its usage/the user(s) who are interacting with it and then to adjust the user experience in some way based on the determined context.

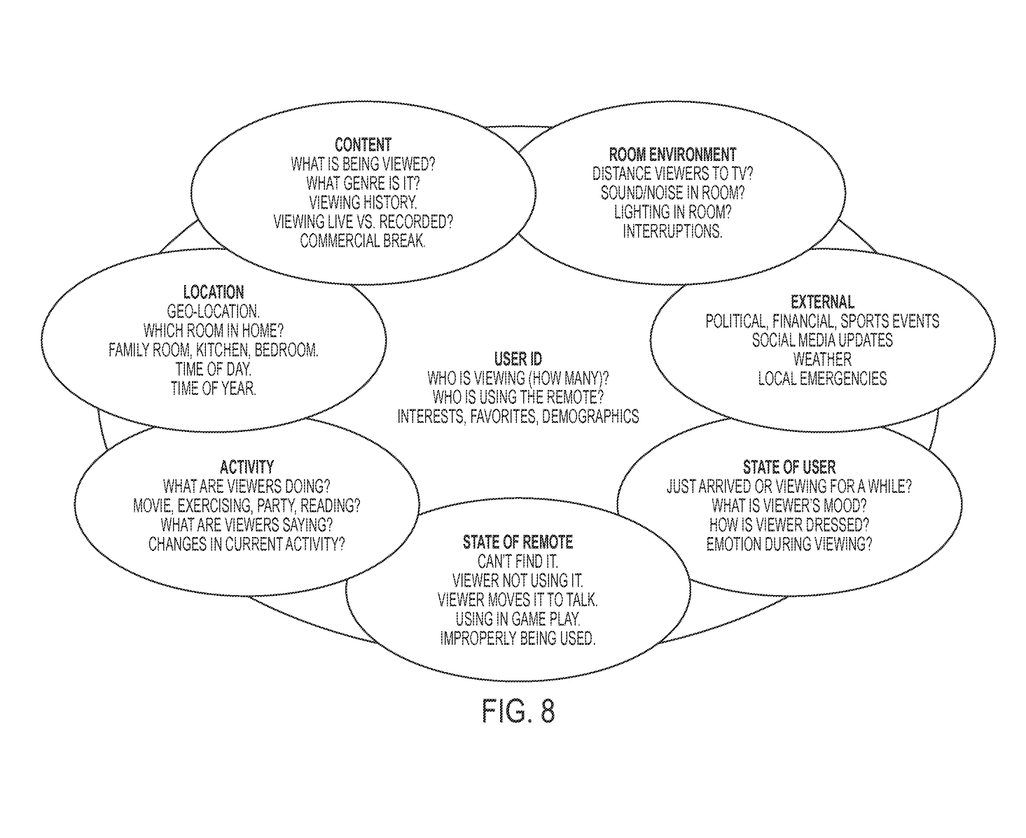

In this regard, context can include, for example and in general, who is interacting with the device, where the device is located, and/or when the interaction is occurring. FIG. 8 provides many more (and more specific) examples of context which can be determined by the smart TV using the afore-described technologies and/or sensors. It will be appreciated by those skilled in the art that embodiments described herein contemplate the determination of one, all or any subset of the contexts described in FIG. 8 by the smart TV, as well as other contexts not explicitly identified in FIG. 8, some of which are described below.

Once the system or device has determined a context associated with the user or users that are interacting with that system or device, one or more actions can be taken by the system or device (e.g., smart TV) to adjust the user experience. A few examples include:

Adjust TV Settings (picture, volume, performance, on/off, etc.)

Customize Remote Control Features and Performance

Control Room Environment

Onscreen and External Alerts

Personalize Experience

User Interface Enhancements
Easy ‘Sign On’
Personalization control (favorites lists, parental controls)
Personalization assistance (most watched, recently watched)
Voice capture without button
Shortcuts

Content Recommendations and Offers

Tuned Advertising

If a remote control device which is used in conjunction with the smart TV includes motion sensing capabilities, e.g., as described above, or if the smart TV otherwise possesses the capability to determine movement of the remote control device, then context aware actions which can be performed by the smart TV can include, for example, those illustrated in Table 1 below.

TABLE 1

| Action | Context |
|---|---|
| Start favorite application | User moves remote with specific gesture |
| Switch TV to game mode | Detect remote used as motion controller |
| | for game |
| | Application type is motion game |
| Turn off TV | Detect user has fallen asleep |
| Alert user | Detect remote has fallen to ground |
| Activate voice capture | User brings remote up to mouth to speak |
| Change personalization | Remote is handed from one person to |
| settings | another |
| | User signs in with unique gesture of |
| | remote |
| Turn off cursor | Detect remote is ‘thrown’ on sofa |
| UI allows custom TV | Detect user is exercising |
| configuration for exercise | Application type is exercise |
| mode | |

In Table 1, some potential actions based on remote control and usage context are listed. Some comments are provided below about these context-based actions.
It is typically nice to have shortcuts for applications that users work with frequently. In this case, a particular motion gesture is assigned to a particular application. The user then doesn't have to use, say, a multi-screen-based API or find a particular button on a 75 button remote to run an application. Rather, the user just makes a particular pattern with the remote—maybe a star—and opens the application of interest (e.g., weather or news).
Latency is very important for game operation. Slow response can make games less fun and, worse case, even unplayable. For optimal movie viewing, though, TV's generally include special video enhancement signal processing that improves the picture. Those processing stages though take time and so can add latency to the system. A context aware TV according to embodiments can automatically switch the TV in and out of game mode based on one of two things—either the remote control is being operated as a game controller or the application now active is a game. This removes the worry of making the proper selection of that TV setting from the user and makes it fully automatic and appropriate to the context.
Some TV's have built-in timers to turn off the TV after a certain amount of time. This can allow users to safely watch TV in bed without worrying that the TV will burn power all night long once they have fallen asleep. However, it's not a complete solution since it may shut off far after the user has fallen asleep or, alternatively, shut off before the user has fallen asleep. The better solution is to detect that user is asleep and then turn off the TV. This could be done several ways including camera observation, infrared observation or actigraphy-based monitoring.
With the typical home, there are a pile of remotes on a table. When not in use, a wayward cat or child could easily send one crashing to the floor. It would be useful to trigger an alert to the user that the remote has unexpectedly dropped to the ground.
The typical remote has too many buttons and can be confusing. If the remote can automatically figure out the operation by leveraging context information, a button can be saved thus improving both the design and usability. One example of this is with voice control. Rather than pressing a button to indicate that mode, the mode could be triggered automatically by noting that the remote control has been lifted up to the user's mouth. This contextual information then indicates that the user wants to activate the microphone and receive vocal input.
Personalization is central to an advanced user experience on the TV. Since the TV is a group device (since multiple people can view it simultaneously), it is important to be clear on which person among the viewers is the one in control. If the TV has been personalized for a parent who then leaves so his child can watch their favorite kid's show, it is important the personal settings on the TV revert to the child's level. This switching can be automated according to an embodiment by taking account of the contextual information that the remote has been handed from one person (e.g., the parent) to another (e.g., the child). In addition, each user might have their own individual gesture that they make with the remote to set up the TV for them.
Advanced TV's typically include some type of cursor control and often that involves motion control. For normal operation, it is implicit that the cursor moves as the remote moves. However, if the remote is simply lying on the seat cushion of a couch and is just moving as the person(s) next to it joggle the cushion, the remote's motion is not something which the users want translated to cursor motion. It would be far better for the TV to note the contextual information that the remote control is no longer in a person's hand and so motion should not result in cursor movement.
There is a big business in exercise video programs. The TV becomes the window to a virtual gym where a trainer exhorts the user through an exercise routine. The TV could enter this mode and configure itself specifically for this form of exercise by detecting that the application type is exercise or by detecting that the user has begun to exercise or warm-up. This then saves the user from having to wade through settings screens to tailor the TV and home entertainment settings appropriately.

Another class of context aware action can, for example, involve user identification use cases. For such cases, once the smart TV has determined a particular context associated with the user(s)' identity(ies), then the smart TV can take a context aware action in response to that determination. Examples of such paired contexts/actions are illustrated in Table 2 below.

TABLE 2

| Action | Context |
|---|---|
| Sign in/Identify user & | Voice recognition |
| demographic | Face recognition |
| | Remote control gesture |
| | Detect user's cell phone |
| | Tremor ID |
| Change TV's personalization | After user identification |
| Favorities, most viewed, | |
| recently viewed | |
| TV settings | |
| Parental controls | |
| Available applications | |
| Interests | |
| Notify User | World/local events related to |
| | emergencies, financial, politics, sports, |
| | etc. based on user's interests |
| | On social media based |
| | recommendations |

It will be appreciated by those skilled in the art that numerous other types of context/action pairings can be identified and implemented in devices such as smart TVs. Further examples are illustrated below in Table 3.

| Action | Context |
|---|---|
| Alert police or other 3^{rd} party | Detect injury to viewer or other |
| | abnormal activity |
| Onscreen recommendation of | Detect party |
| music videos | |
| Onscreen recommendation of | Detect viewer is reading/ |
| soft music channels | studying |
| Onscreen recommendation of movies, | Weather at user's home |
| other video content, etc. | Most recently viewed |
| | Genres or subjects most viewed |
| | Change in stock market |
| | New political event |
| Pause and/or mute content | Detect phone is ringing |
| | Loud conversion is happening |
| | Viewer leaves room |
| Add onscreen ‘last channel’ soft button | Viewer watching multiple |
| | sporting events |
| Dynamically adjust motion settings on | Distance of remote from TV |
| remote for optimal gain and ballistics | Application/UI screen being |
| | viewed |

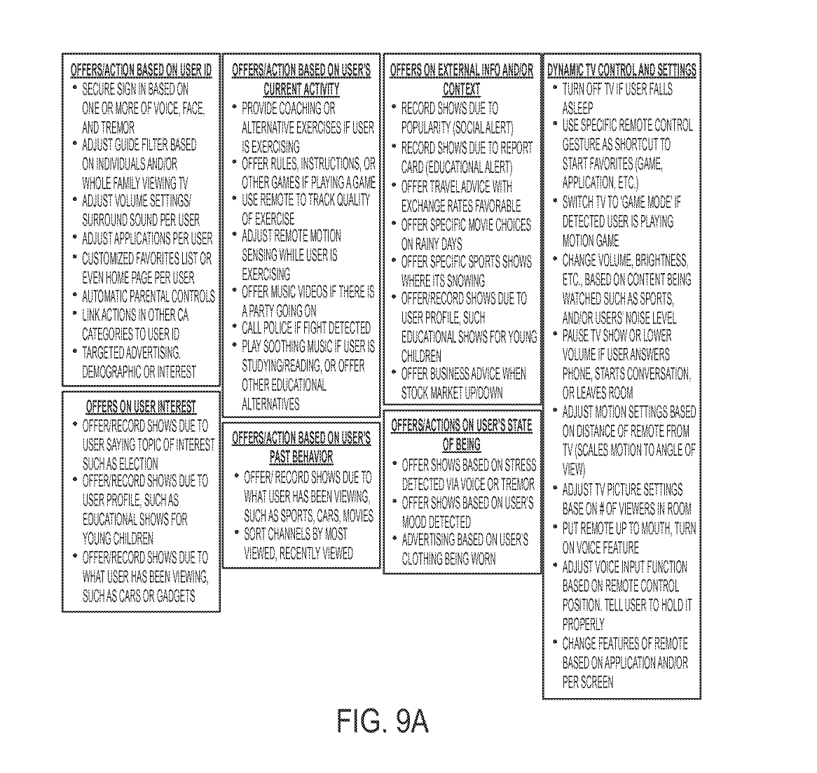

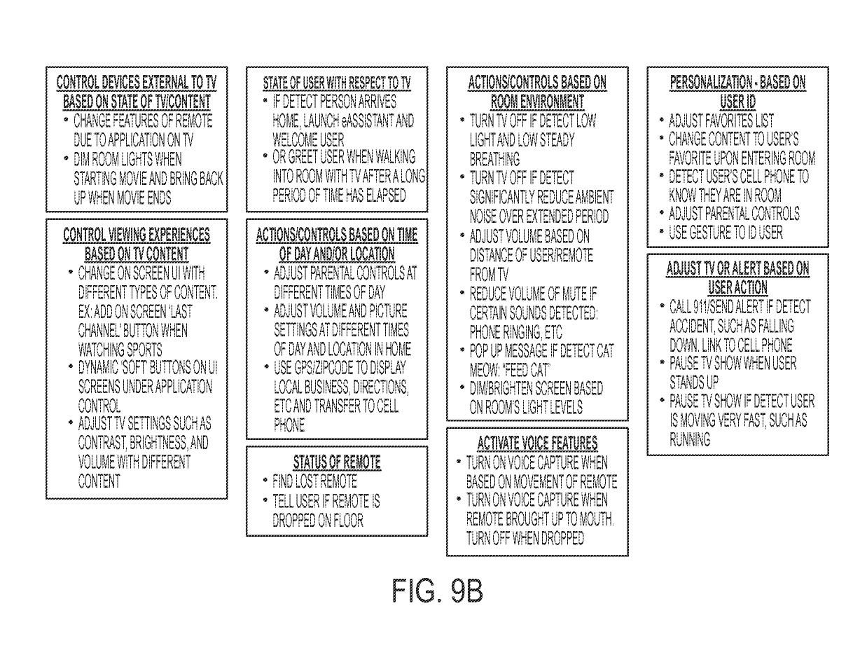

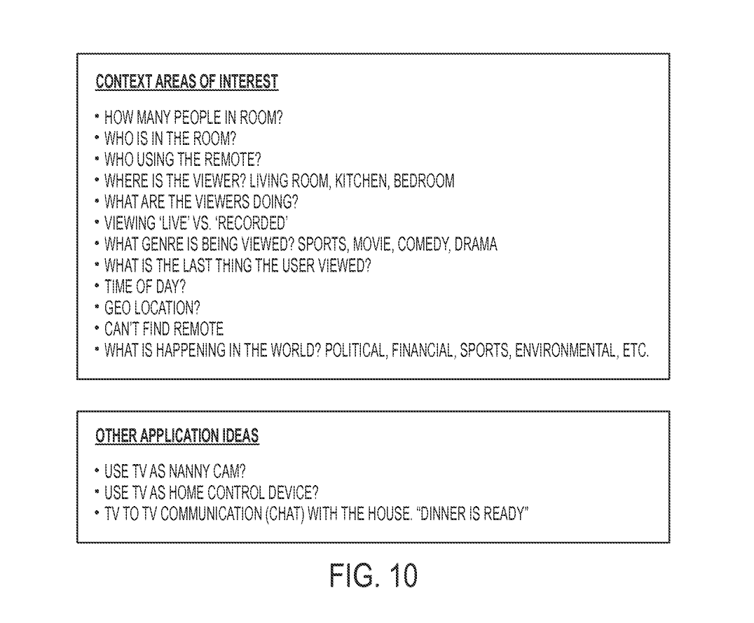

Still further examples of context aware state/action pairings are provided in FIGS. 9(a) and 9(b) according to various embodiments, and additional context aspects are shown in FIG. 10. Embodiments contemplated herein include implementation of one, any subset or all of the contexts and/or determined context/action pairs described herein.

According to one embodiment, context awareness and subsequent context aware actions can be ordered in a predetermined manner. For example, the smart TV can first determine who the user or users are, i.e., perform an identification of the users, e.g., using any of the technologies discussed above. Then, based on which user or users are identified, the smart TV can evaluate one or more subcontexts which are identified specifically based on the identity of the user currently interacting with the smart TV.

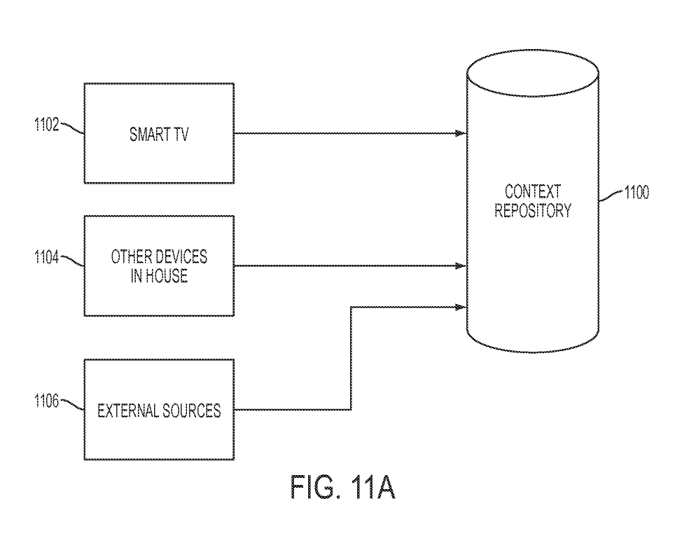

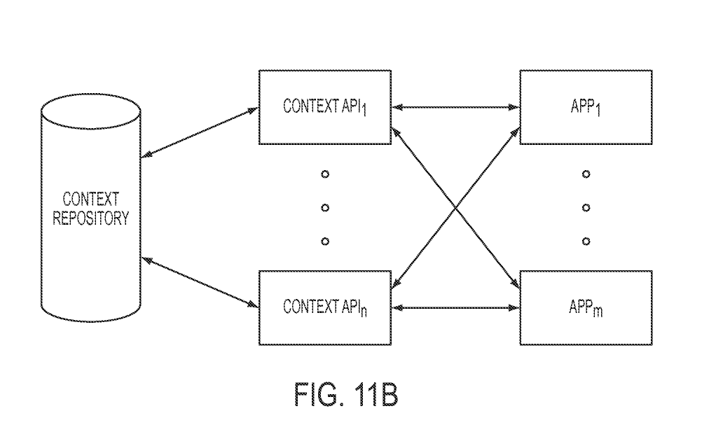

From the foregoing, it will be appreciated that there are potentially a large number of contexts which may be of interest to track, and corresponding context information data elements from which those contexts may be determined. For example, the identity or identities of the person or people in the room with the smart TV can be derived from a number of different pieces of information, e.g., facial recognition from data received from camera in smart TV, gesture input from the remote control device, presence of users personal devices (cell phone, tablet, etc.) in the room and/or numerous other pieces of information. According to some embodiments, it is contemplated that providing a centralized context repository 1100 for the smart TV and/or other devices may be useful to store and provide access to context data, as shown in FIG. 11(a). Some context information may be generated by the smart TV's own sensors 1102, while other context information may be available from other devices in the house 1104 and/or external sources 1106, e.g., the Internet. Either a push or pull mechanism (or combination of both) can be used to, periodically or upon data change, update the relevant context information elements in the context repository 1100. The context repository 1100 can, for example, be implemented in a database or using any type of data structure and can be stored in a memory device either in the smart TV itself or elsewhere in communication with the smart TV.

Similarly, some applications (Appl-Appm) will be concerned with only a few pieces of context information from which they can determine a relevant context of a current user of the smart TV and can request that context data from the context repository 1100 as shown in FIG. 11(b). Context application program interfaces (API1-APIn) can be provided to interact with the applications running on the smart TV to facilitate context data exchange therebetween. The applications may also generate context data which can be stored in the context data repository 1100.

As shown in FIG. 8, context can involve the state of a particular user and/or friends and colleagues, the state of a particular device, an activity, a location, local environmental information, content and/or even external events. In short, context information is very broad indeed. This leads to three lynchpin concepts which are addressed in systems according to various embodiments.

First, a system which implements context-based actions measures, senses or collects the particular context information that is relevant. If a system wants to know if a person (user) is walking or not, the system needs to measure one or more characteristics from which the state “walking” can be determined or inferred. This measurement could, for example, be performed using an accelerometer and/or gyroscope detecting movement and/or gait, e.g., the motion sensor(s) provided in a remote control device as described above, or a sensor provided in or on the smart television described earlier.

As another example, suppose that weather was a context of interest. If a system according to these embodiments wants to determine, e.g., if it is raining as context information to store in the context repository 1100 (or in its own local context database if a centralized context repository is not used), the system can, for example, either directly use a sensor for detecting moisture or, instead, rely on a weather reporting service for the area received over the Internet. For the purposes of these embodiments, it is not necessarily important how context information is gathered since there exists a vast multitude of ways to do that.

Second, they system makes the context information accessible to a consuming application. This means a database or data storage mechanism of some form whether centralized or distributed. FIG. 11 (a) shows an implementation where the Context Repository 1100 is centralized. But that Context Repository could also be distributed physically and in the limit come directly from the sources themselves. In that case, the Context Repository is merely a logical construct representing the way information sources (including sensors and sensor assemblies, devices or other sources) make that information available to an application. This could leverage Internet capability including perhaps an addressing scheme like Internet of Things proposes.

Third, such systems according to embodiments have one or more consuming applications that determine which of the nearly infinite amount of context information available is, in fact, relevant to that application. The set of applications and how they might connect to the Context Repository is shown in FIG. 11(b). Each application decides which context information is relevant and retrieves that information from the sources via the appropriate APIs. As discussed previously, the centralized database style of this Context Repository is only one possible embodiment. That Context Repository could in fact merely be a logical construct representing all the information sources available. In this latter case, each source has at least one Context API through which consuming applications can retrieve the information.

Each individual application typically only needs a subset of contextual information in order to perform its function. So, for example, if the application is a thermostat control system for a house, the unit may only need to know which rooms in the house are occupied, the temperature preferences of the individuals in those rooms, the current temperature in those rooms and potentially the temperature outside along with perhaps overall power consumption and cost goals. Information on the latest show of American Idol or the Facebook status of a particular user is not relevant to this application and so is ignored, not directly obtained by the application or not requested from the Context Repository 1100.

Systems and methods for processing data according to exemplary embodiments of the present invention can be performed by one or more processors executing sequences of instructions contained in a memory device. Such instructions may be read into the memory device from other computer-readable mediums such as secondary data storage device(s). Execution of the sequences of instructions contained in the memory device causes the processor to operate, for example, as described above. In alternative embodiments, hard-wire circuitry may be used in place of or in combination with software instructions to implement the present invention. Such software may run on a processor which is housed within the device, e.g., a 3D pointing device or other device, which contains the sensors or the software may run on a processor or computer housed within another device, e.g., a system controller, a game console, a personal computer, etc., which is in communication with the device containing the sensors. In such a case, data may be transferred via wireline or wirelessly between the device containing the sensors and the device containing the processor which runs the software which performs the bias estimation and compensation as described above. According to other exemplary embodiments, some of the processing described above with respect to context awareness and associated actions may be performed in the device containing the sensors, while the remainder of the processing is performed in a second device after receipt of the partially processed data from the device containing the sensors.

Although the foregoing exemplary embodiments provide for remote devices having sensing packages including one or more rotational sensors and an accelerometer, these exemplary embodiments are not limited to only these types of sensors. Instead remote devices as described herein can be applied to devices which include, for example, only accelerometer(s), optical and inertial sensors (e.g., a rotational sensor, a gyroscope or an accelerometer), a magnetometer and an inertial sensor (e.g., a rotational sensor, a gyroscope or an accelerometer), a magnetometer and an optical sensor, or other sensor combinations.

Although the foregoing embodiments described context awareness with a focus on smart televisions, it will be appreciated that these techniques are not limited for use in conjunction with televisions but can be used with other smart devices, e.g., mobile phones, tablets, personal computers, refrigerators, cars, etc.

The above-described exemplary embodiments are intended to be illustrative in all respects, rather than restrictive, of the present invention. Thus the present invention is capable of many variations in detailed implementation that can be derived from the description contained herein by a person skilled in the art. For example, although the foregoing exemplary embodiments describe, among other things, the use of inertial sensors to detect movement of a device, other types of sensors (e.g., ultrasound, magnetic or optical) can be used instead of, or in addition to, inertial sensors in conjunction with the afore-described signal processing. All such variations and modifications are considered to be within the scope and spirit of the present invention as defined by the following claims. No element, act, or instruction used in the description of the present application should be construed as critical or essential to the invention unless explicitly described as such. Also, as used herein, the article “a” is intended to include one or more items.

What is claimed is:

1. A method for performing a context-based action in a television, the method comprising:
determining, by the television, at least one piece of context information associated with a current usage of the television, and
performing, by the television, the context-based action based on the at least one piece of context information.

2. The method of claim 1, wherein the context-based action is switching into a game mode, and wherein the at least one piece of context information is at least one of whether a remote control device is being operated as a game controller and whether an application type being run on the television is a game.

3. The method of claim 2, wherein switching into a game mode further comprises:
reducing, by the television, image processing to reduce latency.

4. The method of claim 1, wherein the context-based action is changing personalization settings on the television, and wherein the at least one piece of context information is an identity of a current user of the television.

5. The method of claim 4, wherein the television determines the identity of the current user of the television by one of voice recognition, face recognition, gesture or detection of a user's cell phone.

6. The method of claim 1, wherein the context-based action is turning on or off cursor movement, and wherein the at least one piece of context information is whether a remote control device is in a user's hand.

7. The method of claim 6, further comprising:
determining whether the remote control device is in the user's hand based on at least one of input from a camera connected to the television and motion information from the remote control device.

8. The method of claim 1, wherein the context-based action is entering an exercise mode, and wherein the at least one piece of context information is one of an application type being exercise and a user beginning to exercise.

9. The method of claim 1, wherein the context-based action is entering a voice capture mode, and wherein the at least one piece of context information is a remote control device being proximate a user's mouth.

10. The method of claim 1, wherein the context-based action is changing personalization settings on the television, and wherein the at least one piece of context information is an identity of a current user of the television.

11. A smart television system comprising:
a television display;
at least one television media input configured to receive television programming signals from at least one of a cable TV network and a satellite TV network;
at least one Internet media input configured to receive Internet content;
a plurality of sensors including at least two of: a camera, a microphone, an infrared device, and a motion sensor;
a processor configured to output television programming or Internet content to the display and further configured to receive inputs from the plurality of sensors, and to determine a context associated with a current usage of the smart television system based, at least in part, on the received inputs,
wherein the processor is further configured to use the determined context to perform a context-based action.

12. The smart television system of claim 11, wherein the plurality of sensors includes the microphone and the camera, the processor is configured to use the camera to detect that a user has moved a remote control device associated with the smart television into proximity with his or her mouth as the determined context, and the context-based action is to activate a voice capture process using the microphone.

13. The smart television system of claim 11, further comprising a remote control device whose motion can be detected either by one of the plurality of sensors or based on one or more motion sensors within the remote control device, wherein
the processor is configured to receive information associated with movement of the remote control device, detects motion of the remote control device which indicates that the remote control device is being used as a motion controller for a game, and switches the television system into a low latency image processing mode.

14. The smart television system of claim 11, wherein the plurality of sensors includes a microphone, the processor is configured to perform a voice recognition on captured voice samples of a user of the smart television system using the microphone, the context is the identity of the user based on the voice recognition, and the context-based action is to change one or more personalization settings based on the identity.

15. The smart television system of claim 14, wherein the one or more personalization settings include one or more of: display favorite television program, display favorite Internet Web page, television settings, parental controls, and displayed available applications.

16. The smart television system of claim 11, wherein the plurality of sensors includes a camera, the processor is configured to perform a face identification on a captured image of a user of the smart television system using the microphone, the context is the identity of the user based on the face recognition, and the context-based action is to change one or more personalization settings based on the identity.

17. The smart television system of claim 16, wherein the one or more personalization settings include one or more of: display favorite television program, display favorite Internet Web page, television settings, parental controls, and displayed available applications.

18. The smart television system of claim 11, wherein the context-based action is entering an exercise mode, and the context one of an application type being exercise and a user beginning to exercise.

19. The smart television system of claim 11, wherein the context-based action is entering a voice capture mode, and wherein the context is a remote control device being proximate a user's mouth.

20. A method for performing context based actions by a smart television, comprising:
determining an identity of a user of the smart television;
evaluating one or more subcontexts associated with the identified user; and
performing the context-based action based on the evaluating.

21. A context repository system associated with household devices comprising:
a memory device configured to store a database of context information associated with the household devices, their environment and their users;
a plurality of interfaces, each associated with one of the household devices, for receiving context information from the household devices and for transmitting context information to the household devices;
a processor configured to receive the context information from the household devices, to store the received context information in the database, and
further configured to receive requests for context information from the household devices, to retrieve the requested context information from the database and to transmit the requested context information back to the requesting household devices.

22. The context repository system of claim 21, wherein the context information includes at least one of: a current user of one or more of the household devices, a current weather associated with the household, a time of day, a current application being executed on one or more of the household devices.

23. The context repository system of claim 21, wherein the context information includes each of: a current user of one or more of the household devices, a time of day, and a current application being executed on one or more of the household devices.
